(19) United States
(12) Patent Application Publication
(10) Pub. No.: US 2015/0252566 A1
(43) Pub. Date: Sep. 10, 2015

(54) Glass Roofing Granules

(71) Applicant: 3M INNOVATIVE PROPERTIES COMPANY, St. Pau;, MN (US)

(72) Inventors: Jean A. Tangeman, Minneapolis, MN (US); Craig W. Lindsay, Minneapolis, MN (US); Kenton D. Budd, Woodbury, MN (US); Rebecca L. Everman, St. Paul, MN (US); Jeffry L. Jacobs, Hastings, MN (US); John S. Edwards, Hudson, WI (US)

(73) Assignee: 3M INNOVATIVE PROPERTIES COMPANY, St. Paul, MN (US)

(21) Appl. No.: 14/425,903

(22) PCT Filed: Sep. 6, 2013
(86) PCT No.: PCT/US2013/058466

§ 371 Date: Mar. 4, 2015

Related U.S. Application Data
(60) Provisional application No. 61/699,672, filed on Sep. 11, 2012.
(60) Provisional application No. 61/749,707, filed on Jan. 7, 2013.

(51) Int. Cl. E04D 1/00; C03B 19/09; C03C 14/00; C03C 4/02; A01N 25/12; C03C 4/14; C03C 4/08; B01J 21/08; C03B 19/06; B01J 35/00

(52) U.S. Cl. CPC E04D 1/00; C03B 19/06; C03B 19/09; C03C 14/004; B01J 35/004; A01N 25/12; C03C 4/14; C03C 4/082; B01J 21/08; C03C 4/02; E04D 2001/005

(57) ABSTRACT

Building materials, such as roofing granules, including greater than 50% volume of glass are provided. In an exemplary embodiment, one or more additives including colored pigments, infrared-reflective particles, infrared-absorbing particles, algicidal particles, photocatalytic particles, thermally conductive particles, or electrically conductive particles are incorporated at least partially throughout or onto the granule.

### TECHNICAL FIELD

The present disclosure relates to building materials and in particular building materials, such as roofing granules, derived from fine glass particles.

### BACKGROUND

Many surfaces benefit from the presence of granules. For example, asphalt-based roofing materials are often used to cover roofs on homes and other structures, and typically include an asphalt-containing substrate and a plurality of granules.

Various building materials, such as roofing products, may be used for a multitude of applications having various performance demands. Roofing products may include granules including a mineral baserock and one or more coatings that provide desired features and characteristics. Traditional granules may include colored coatings to provide desired aesthetic value, photocatalytic or algicidal coatings, or coatings designed to provide desirable energy management properties.

### SUMMARY

In an exemplary embodiment, a building material is provided including a roofing granule having greater than 50% by volume of a glass. In some embodiments, the roofing granule includes an additive incorporated at least partially throughout the glass. In various embodiments, the additive includes one or more materials selected from a group consisting of colored pigments, infrared-reflective particles, infrared-absorbing particles, algicidal particles, photocatalytic particles, thermally conductive particles, and electrically conductive particles.

In some exemplary embodiments, a building material is provided including a roofing granule having greater than 50% by volume of a glass-ceramic. In some embodiments, the roofing granule includes an additive incorporated at least partially throughout the glass-ceramic. In various embodiments, the additive includes one or more materials selected from a group consisting of colored pigments, infrared-reflective particles, infrared-absorbing particles, algicidal particles, photocatalytic particles, thermally conductive particles, and electrically conductive particles.

In another exemplary embodiment, a roofing product is provided including a plurality of roofing granules comprising greater than 50% by volume of a glass distributed on a substrate, wherein each roofing granule includes an additive distributed at least partially throughout the roofing granule, the additive selected from the group consisting of colored pigments, infrared-reflective particles, infrared-absorbing particles, algicidal particles, photocatalytic particles, thermally conductive particles, and electrically conductive particles.

In a further exemplary embodiment, a method of making a roofing granule is provided. The method includes steps of processing bulk glass into a fine glass powder, disposing the fine glass powder in a forming device, and heat treating the fine glass powder in the forming device to cause at least partial densification of the glass powder.

### BRIEF DESCRIPTION OF THE DRAWINGS

FIG. 1 shows an exemplary roofing granule according to the present invention.

FIG. 2 shows an exemplary roofing granule including coatings according to the present invention.

FIG. 3 shows an exemplary roofing product including a plurality of roofing granules according to the present invention.

FIGS. 4A-4E are representative scanning electron microscope images illustrating porosities of example roofing granules formed according to embodiments of the present disclosure.

While the above-identified figures set forth various embodiments of the disclosed subject matter, other embodiments are also contemplated. In all cases, this disclosure presents the disclosed subject matter by way of representation and not limitation. It should be understood that numerous other modifications and embodiments can be devised by those skilled in the art which fall within the scope and spirit of the principles of this disclosure.

### DETAILED DESCRIPTION

The present disclosure relates generally to building materials, such as roofing granules, tiles, or other suitable building materials, derived from fine glass particles. Building materials derived from fine glass particles may provide a high level of customizability, such that additives, coatings, or other modifications may be applied to provide a building material exhibiting specific performance attributes as may be desired for a particular application. In various exemplary embodiments, building materials having a high percentage composition of glass may provide solar opaqueness and relatively low solar absorption such that the building materials exhibit high total solar reflectivity. In various other exemplary embodiments, building materials having a high percentage composition of glass may incorporate various additives, coatings, or other modifications to exhibit desired colors, infrared-reflective properties, infrared-absorbing properties, algicidal properties, photocatalytic properties, thermally conductive properties, electrically conductive properties, environmentally filtering properties, and/or other features and characteristics.

In some embodiments, a glass used in exemplary building materials such as roofing granules comprises a silicate glass, such as soda lime silica, as may be commonly used in windows and bottles. Borosilicates and other glasses can be used to achieve different heat treatment ranges, chemical durability, devitrification, or optical properties. In some exemplary embodiments, aluminosilicate glasses, phosphate glasses, borate glasses, and other suitable glasses as known in the art are used. Moderate to high purity, low iron glass compositions may be suitable where high total solar reflectance (TSR) white or uncolored granules are desired. In some exemplary embodiments, the glass is a custom manufactured glass. In some exemplary embodiments, the glass is a pre-fused glass and/or recycled glass. Pre-fused glasses are glasses previously made by a melt process, and may include ordinary silicates such as soda lime silica, borosilicate, and other suitable materials. Recycled glasses are pre-fused glasses manufactured for an initial use, such as windows, bottles, labware, etc., for example, and are re-processed for another use.

To form granules, bulk glass is first treated to form a fine glass powder. In some embodiments, the glass particles have particle sizes ranging from about 0.3 μm to 10 μm. Glass powders can be formed by milling methods such as ball milling or attritor milling. In some embodiments, the glass powders is co-milled or post blended with pigments, binders, liquids, and/or other additives such that the additives may be partially or completely incorporated throughout the glass substrate of the resulting granule.

A green body of not fully strengthened or heat treated material results from forming dried bricks, cakes, pellets, aggregates, or agglomerates of the fine glass powder. In some exemplary embodiments, additives are included to improve green strength. For example, zinc additives such as zinc sulfate, and/or zinc borate may improve mechanical strength, and is further believed to improve the chemical durability of the final building material. Other additives, such as aluminosilicates, may also improve mechanical strength. Particle size of the fine glass powder is also believed to affect green strength, with a smaller particle size generally resulting in higher strength. An increased green strength may provide several manufacturing advantages including, for example, lowered production of unwanted fine particles in embodiments in which dried materials are subsequently crushed or reduced to a desired size, and less creation of dust during handling.

The green body formed from the fine glass particles may be heat treated to cause partial or full densification of the glass particulate structure. The heat treatment causes at least partial coalescence, fusing, viscous flow, or viscous sintering of the glass particles. Typically, heat treatment is done near or above the softening point of the glass. For example, for borosilicate glass, heat treatments from about 600° C. to about 1000° C. may be used.

One or more additives may be incorporated with the fine glass particles to lower the glass transition temperature of the glass particles. In various exemplary embodiments, nepheline syenite, feldspar, borax, spodumene, suitable fluxes, and other suitable additives as known in the art may be incorporated with the fine glass particles. Lowering the glass transition temperature may allow lower temperature and/or duration of heat treatment and thus is believed to provide energy savings and may allow incorporation of additives that may break down or otherwise be damaged at higher processing temperatures.

Variations on the described fabrication process are also possible. For example, dried materials larger than desired granule sizes can be crushed prior to or subsequent to firing. In addition, dried or fired material outside the desired granule size range can be recycled into the milling stage of the process. Further, dried particles of desired geometric shapes and sizes can alternatively be made without crushing by methods such as agglomeration, casting, molding, etc. of liquid slurries or gels. In an exemplary embodiment, such geometric shapes include regular shapes such as rectangular prisms, triangles, tetrahedrons, and other suitable shapes. Granules can thus be provided with a desired shape to optimize coverage, exhibit desired optical properties, or provide other features and characteristics, for example. Still further, components, coatings or additional materials can be adhered to or incorporated on the surfaces of the particles prior to firing.

In various exemplary embodiments, granules may be fabricated to include pores that affect the reflectivity of the granules. For example, pores may be formed by partial densification of fine glass particle agglomerates. Pore volume and pore size may be controlled in part by initial glass powder particle size distribution, and by the heat treatment time and temperature. Pores can also result from dissolved gas release during heat treatment, and the composition of the glass and/or additives can be incorporated for this purpose. Porosity can be engineered or controlled to provide high reflectivity, as described further below.

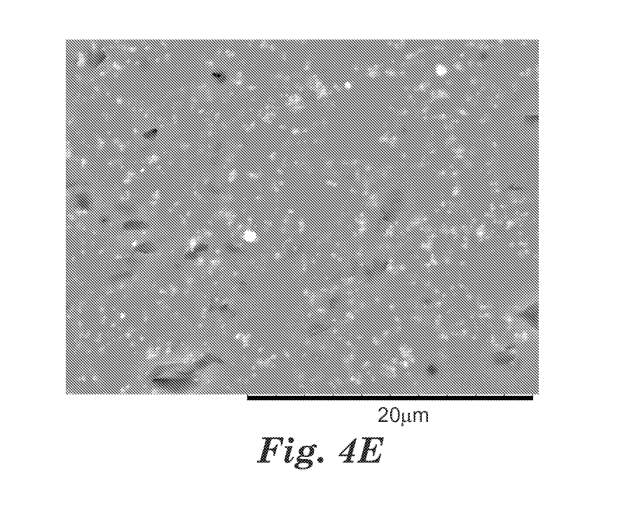

In some exemplary embodiments, pore sizes (e.g., diameter or largest distance across) range from less than 1 um to about 100 um. In other embodiments, pore sizes range from about 0.3 um to 10 um. In some cases, the granules include a pore volume percent of between about 0% and 35%. For example, in some exemplary embodiments, the pore volume percent is between about 3% and 15%. Such pore volume is believed to provide high reflectivity in combination with high mechanical durability. In other exemplary embodiments, pore volume percent of 15% to 20%, or greater than 20% may provide a suitable balance of reflectivity and high mechanical durability. In some exemplary embodiments, pore volume percent may be less than 3%. FIGS. 4A through 4E show scanning electronic microscope views of various exemplary embodiments showing two-dimensional views having less than approximately 18%, 16%, 9%, 10%, and 4% area percent of pores, respectively.

Densification of fine glass particles can be used to provide closed porosity of the pores in the granules, either because of local coalescence, surface sealing, or gas evolution. Closed pores can be advantageous for stain resistance or chemical durability. In some embodiments, the granules include a closed pore volume percent of at least about 3% and/or an open pore volume percent of no greater than about 5%.

In some exemplary embodiments, the glass particles are fully sintered or coalesced and thus fully densified to form a substantially pore free substrate. The glass substrate may exhibit less than 1% by volume of pores, less than 0.5% by volume of pores, nearly 0% by volume of pores, or 0% by volume of pores.

In exemplary embodiments, porosity of building materials derived from fine glass particles may be selected to provide a desired density. While pigments or additives such as titania, zinc oxide, or barium sulfate may have a relatively higher density, and thus raise the density, of the final granule, the porosity may be increased or decreased to increase or decrease the density of the granule. For example, a relatively higher porosity may result in a granule having a density of less than 2.5 g/cm³ or less than about 2 g/cm³, and a relatively lower porosity may result in a granule having a density of greater than 2.5 g/cm³ or greater than about 3 g/cm³, for example. A desired porosity may also be selected for applications in which granules exhibiting different compositions may be blended. Controlling porosity such that granules having different compositions exhibit similar densities may promote uniform distribution and avoid segregation of the different granule types.

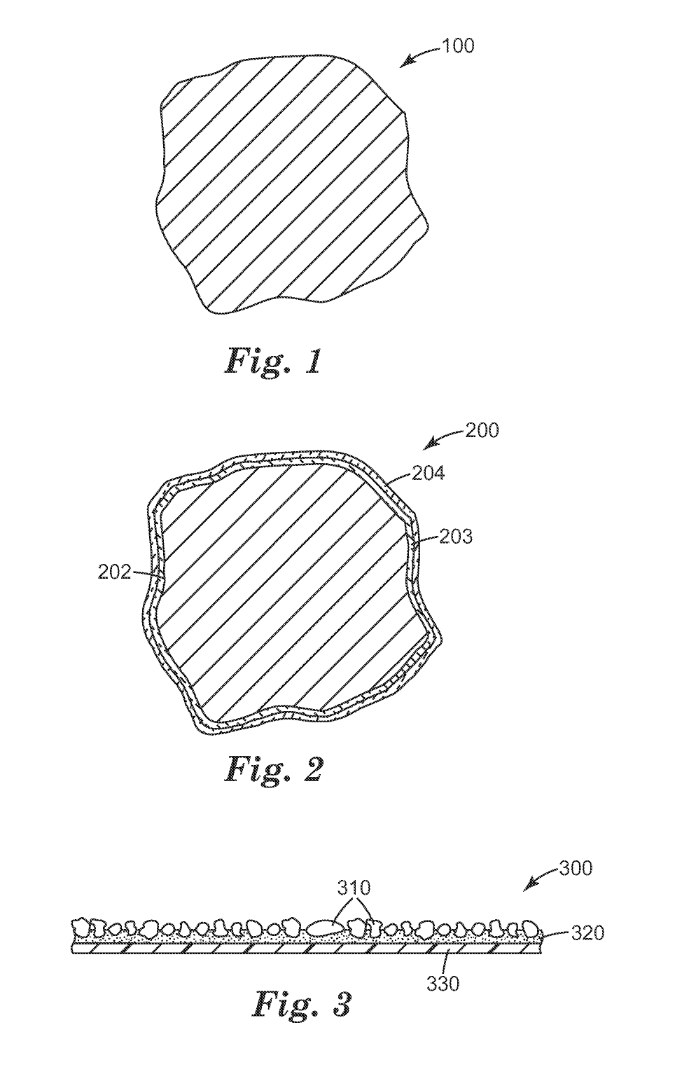

Building materials, such as roofing granules, as described herein include a relatively high volume of glass. In various exemplary embodiments, building materials, such as roofing granules, according to the present invention may include greater than 50% by volume of a glass, or greater than 75% by volume of a glass, or greater than 90% by volume of a glass. A building material having greater than 50% by volume of a glass, for example, results in a building material such as a roofing granule including a glass substrate that may incorporate one or more additives, or be coated with one or more coating compositions, to exhibit desired features and characteristics. In certain exemplary embodiments, a granule having 50% by volume of a glass may be desirable to provide specific features and characteristics, as described herein, for example, while in certain embodiments a granule having greater than 50%, 60%, 70%, 80%, 90%, 95% or nearly 100% may be suitable. FIG. 1 provides an exemplary embodiment of a roofing granule 100 including greater than 50% by volume of a glass.

In some embodiments, the fine glass particles may at least partially crystallize during heat treatment such that a portion of the building material is a glass-ceramic. In various exemplary embodiments, a roofing granule according to the present disclosure may include greater than 5% by volume of a glass-ceramic, or greater than 50% by volume of a glass-ceramic, or greater than 90% by volume of a glass-ceramic, and/or may include both glass portions and glass-ceramic portions.

In an exemplary embodiment, roofing granules according to the present invention exhibit an average particle size between about 300 μm to about 5000 μm in diameter. Particle size may refer to a largest dimension of a granule. A roofing granule as described herein allows various shapes or size distributions to be selected as may be suitable for a particular application. In an exemplary embodiment, a plurality of roofing granules are provided having a narrow size distribution such that a high percentage of granules have a size within a small range from a median particle size. In various exemplary embodiments, 50%, 75%, or even 90% or more of granules have a particle size or mass within 30%, 20%, 10%, or less than 10% of an average granule particle size or mass. Accordingly, granules according to the present invention may facilitate a more uniform size distribution that may provide advantages in application and coverage on a substrate, such as a substrate of a roofing shingle. In some exemplary embodiments, a bimodal distribution may be provided that include relatively larger flat square granules, for example, and small tetrahedrons to optimize coverage. Most of a substrate is covered by the relatively larger flat square granules while small tetrahedrons fill gaps that may otherwise exist between the square granules. In some embodiments, undesirable segregation of granules of differing sizes may be alleviated by controlling the density of the granules.

Building materials derived from fine glass materials may include features, characteristics or additives to provide building materials suitable for a desired application or function. For example, one or more additives may be incorporated with a glass powder before the glass powder is sintered, fused, coalesced, and/or formed into a roofing granule, tile, or other suitable building material, or the fabrication process may be controlled to provide a building material exhibiting desired features or characteristics. In some exemplary embodiments, the building materials include less than 50% by weight of an additive, less than 25% by weight of an additive, less than 10% by weight of an additive, or less than 1% by weight of an additive. Alternatively or in addition, a suitable coating or coatings including one or more additives may be coated onto a glass substrate according to the present disclosure. Various additives may be selected to provide high total solar reflectance (TSR), colored, infrared(IR)-reflective, IR-absorbing, thermally conductive, algae resistant, photocatalytic, environmental filtering, and/or shaped building materials, or exhibiting other desired properties, as will be described in greater detail below.

In some exemplary embodiments, granules exhibit a desired porosity and/or pigments such that the granules may exhibit high total solar reflectance granules due to the diffuse reflectance of the pores and low solar absorption of the glass. The granules exhibit “low solar absorption” as the granules may primarily reflect or transmit a large fraction of the total solar spectrum, and would therefore primarily reflect or transmit most of the visible and near IR spectrum. In some embodiments, a low solar absorption material would absorb less than 50%, preferably less than 30%, and optimally less than 20% of the total solar spectrum.

The glass, additives, and/or coatings may also result in a solar opaque granule that has low transmission of the total spectra. When a material is both solar opaque and has low solar absorption, it has high total reflectivity of the solar spectrum. In various exemplary embodiments, a functional amount of a solar opaque material would transmit less than 60%, more preferably less than 40%, and optimally less than 30% of the total solar spectrum.

The glass particles are sufficiently sintered, fused, or coalesced to provide desired strength and sufficiently limited open porosity. In addition, the granules can comprise sufficient additional closed porosity and pigments to provide high reflectivity and ultraviolet (UV) blocking properties. In some embodiments, the granule features enable roofing having a total solar reflectance of up to or even greater than 70% (e.g., 25%, 30%, 35%, 40%, 45%, 50% 55%, 60%, 65%, 70%, 75%, 80%, 85%, or 90%), and have moderate to low cost. Alternatively, the granules of the present disclosure can be used as a baserock that is coated with a high TSR coating. The granules have applicability with a variety of roofing materials, such as shingles, roll roofing, cap sheets, stone coated tile, as well as other non-roofing surfaces, such as walls, roads, walkways, and concrete.

Higher performance white granules can be used for commercial bitumen roofs. Granules that enable roofs with an initial TSR value of at least 70% of the total solar spectrum can meet new building energy rating requirements, resulting in considerably increased value of the roofing product. The granules themselves optimally have extremely high reflectivity, as there can be losses from granule post treatments and incomplete coverage of bitumen surface. Granule cup reflectivity requirements can be as high as about 78% to about 90%. In various exemplary embodiments, granules according to the present invention include a combination of sufficiently high scattering power, sufficiently low absorption, and high UV blocking. Scattering power can be controlled by refractive index contrast and particle size.

Other approaches to enhanced scattering include the development or trapping of light scattering pores, as discussed in more detail herein, lowering the refractive index of the binder matrix, or using lower cost pigments (such as, for example, alumina) that enhance overall scattering due to the ability to use larger quantities or trap small pores.

An IR-reflective building material according to the present disclosure is believed to provide high IR-reflective performance. A roofing granule derived from fine glass materials as described herein may itself be IR-reflective, in contrast to the mineral substrate of traditional roofing granules which may be IR-absorbing. IR-reflectivity of a roofing granule described herein may be relatively greater due to the absence of an IR-absorbing mineral substrate.

In an exemplary embodiment, building materials derived from fine glass materials may include characteristics or additives to provide colored building materials, such as colored roofing granules. The porosity and density of a glass roofing granule as described above may be tailored to obtain a sufficiently durable granule, and any suitable colored pigment may be added to provide a desired color. In an exemplary embodiment, one or more colored pigments can be incorporated with a glass powder before the glass powder is sintered, fused, coalesced, and/or formed into a roofing granule, tile, or other suitable building material. In this way, one or more colored pigments may be partially or completely incorporated throughout the glass substrate. In an exemplary embodiment, a colored roofing granule comprises about 85 weight % of a borosilicate glass, about 8 weight % titanium dioxide, and about 7 weight % red iron oxide. Other suitable colored pigments may be incorporated into the glass powder as desired.

Colored building materials derived from fine glass materials may provide greater color saturation than traditional building materials. For example, a roofing granule exhibiting a colorless or relatively colorless glass substrate and incorporating one or more colored pigments results in the visible color of the roofing granule to appear closer in color to the colored pigment alone. Without being bound by theory, a colorless or relatively colorless glass substrate is believed to not significantly interfere with the observed color of the colored roofing granule, as compared to a roofing granule having a mineral substrate exhibiting a visible color that affects the color of the final coated roofing granule. A colorless or relatively colorless glass substrate may also allow for a broader range of colored roofing granules that could not easily be obtained using traditional mineral roofing granules.

In various exemplary embodiments, the color of building materials derived from fine glass particles may be characterized with L*, a*, b* numbers. L*, a*, b* numbers indicate color scales in light-dark, red-green, and yellow-blue, respectively, and all three numbers are needed to describe the color of an object. For two different objects, the difference in their L*, a*, b* numbers represents the difference in their colors. In an exemplary embodiment, a colored building material, such as a roofing granule, having a specified quantity of pigment is believed to exhibit a truer, more highly saturated color, as exhibited by its L*, a*, b* numbers, than a traditional coated mineral granule with a coating have a composition representative of the same quantity of pigment.

In addition to color, pigments and other additives may be incorporated with a glass powder before the glass powder is sintered, fused, coalesced, and/or formed into a roofing granule, tile, or other suitable building material to provide optical effects such as reflectivity and UV blocking For example, for high TSR granules, strongly scattering pigments such as titania can be used to provide both high reflectivity and UV blocking Other pigments, such as alumina, silicates, and other oxides can also be used. For example, zinc oxides are moderately good scatterers and more UV absorbing in certain wavelength ranges (340-380 nm) than titania. Pigment types and amounts can be chosen based on performance, cost effectiveness, and compatibility with granule process temperatures. For example, in some embodiments, the granules comprise about 1 to 10 weight % titania, and for example may comprise about 92 weight % of a glass and about 8 weight % of a titania. In some embodiments, the granules comprise titania and at least one other pigment. In some embodiments, the granules comprise a near UV absorbing pigment and an additional reflective pigment.

In an exemplary embodiment, granules that may be referred to as “cool” granules reflect a significant portion of incident infrared light. In some cases, the cool granules may be formed of a glass material, such as described herein, and bearing one or more coatings or layers including one or more infrared light reflecting pigments. A suitable pigment includes titanium dioxide, which yields a white appearance. Suitable pigments providing a yellow color include V-9415 and V-9416 (Ferro Corp., Cleveland, Ohio) and Yellow 195 (the Shepherd Color Company, Cincinnati, Ohio), all of which are considered yellow pigments.

In some cases, darker pigments may be used that have enhanced NIR reflectivity. These pigments include “10415 Golden Yellow,” “10411 Golden Yellow,” “10364 Brown,” “10201 Eclipse Black,” “V-780 IR BRN Black,” “10241 Forest Green,” “V-9248 Blue,” “V-9250 Bright Blue,” “F-5686 Turquoise,” “10202 Eclipse Black,” “V-13810 Red,” “V-12600 IR Cobalt Green,” “V-12650 Hi IR Green,” “V-778 IR Brn Black,” “V-799 Black,” and “10203 Eclipse Blue Black” (all from Ferro Corp.); and Yellow 193, Brown 156, Brown 8, Brown 157, Green 187B, Green 223, Blue 424, Black 411, Black 10C909 (all from Shepherd Color Co.). In an exemplary embodiment, a roofing granule comprises about 85 weight % of a borosilicate glass, about 8 weight % titanium dioxide, about 3 weight % of SICOPAL Orange L2430, available from BASF of Charlotte, N.C., and about 4 weight % of V-778 Black pigment, available from Ferro Corp. of Cleveland, Ohio. Additional pigments of interest, some displaying enhanced infrared light reflectivity, are discussed in Sliwinski et al., U.S. Pat. Nos. 6,174,360 and 6,454,848, both of which are herein incorporated by reference, in their entirety. In other embodiments, the granules include non-IR reflective pigments.

Alternatively or in addition, a ceramic coating including one or more colored pigments may be coated onto the glass substrate. For example, a glass substrate may be coated with a composition including a colored pigment and an alkali metal silicate binder, which may include lithium silicate, sodium silicate, potassium silicate, and/or combinations thereof. In some exemplary embodiments, an alkoxysilane, such as tetraethoxysilane, and/or a boric acid, borate, or combination thereof, may be added to enhance the durability of the coating, as described by U.S. Pub. No. 2011/0251051 dated Oct. 13, 2011, and U.S. Pub. No. 2010/0152030 dated Jun. 17, 2010, respectively, the entirety of each which is incorporated herein by reference. After applying a coating composition onto the glass substrate, the coated glass substrate is heated at elevated temperatures in a rotary kiln, oven, or other suitable apparatus, to produce a colored building material, such as a colored roofing granule.

In some exemplary embodiments, the granules may be coated using an aqueous slurry of pigment, alkali metal silicate, an aluminosilicate, and an optional borate compound. The alkali metal silicate and the aluminosilicate act as an inorganic binder and are a major constituent of the coating. As a major constituent, this material is present at an amount greater than any other component and in some embodiments present at an amount of at least about 50 volume percent of the coating. The coatings from this slurry generally result in a ceramic.

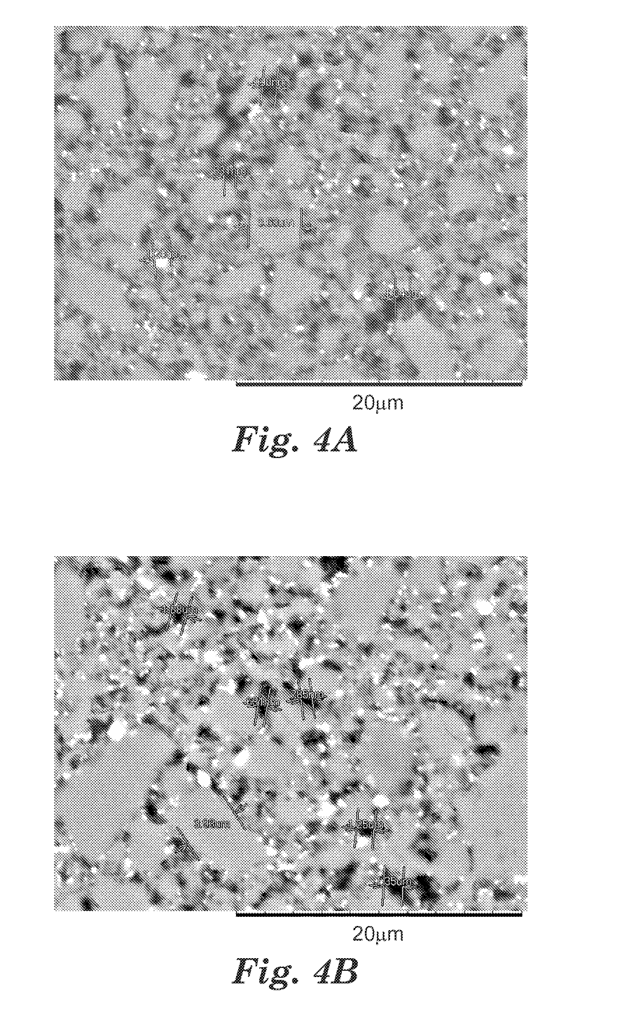

FIG. 2 provides an exemplary embodiment of a roofing granule 200 including greater than 50% by volume of a glass, as described herein, and exhibiting a surface 202 coated with a coating 203 that may include one or more components as described herein. In some exemplary embodiments, coating 203 may enter various pores (not shown) such that coating 203 covers surface 202 and/or at least some inner surfaces of granule 200. In some exemplary embodiments, a second coating 204 may be provided over coating 203.

An exemplary alkali metal silicate coating composition may include an aqueous sodium silicate which may be advantageous due to its relative availability and economy, although similar materials such as potassium silicate may also be substituted wholly or partially therefore. The alkali metal silicate may be designated as M₂O:SiO₂, where M represents an alkali metal such as sodium (Na), potassium (K), mixture of sodium and potassium, and the like. The weight ratio of SiO₂ to M₂O can range from about 1.4:1 to about 3.75:1. In some embodiments, weight ratio of SiO₂ to M₂O is about 2.75:1 or about 3.22:1, depending on the color of the granular material to be produced, the former may be more suitable when light colored granules are produced, while the latter may be more suitable when dark colored granules are desired.

The aluminosilicate used can be a clay having the formula Al₂Si₂O₅(OH)₄. Another preferred aluminosilicate is kaolin, and its derivatives formed by weathering (kaolinite), moderate heating (dickite), or hypogene processes (nakrite). Other commercially available and useful aluminosilicate clays for use in the ceramic coating of the granules in the present invention are the aluminosilicates known under the trade designations DOVER from Grace Davison of Columbia, Md. and SNO-BRITE from Unimin Corporation of New Canaan, Conn.

The borate compound, may be sodium borate available as BORAX available from U.S. Borax Inc. of Valencia, Calif. Other suitable borates may be used, such as zinc borate, sodium fluoroborate, sodium tetraborate-pentahydrate, sodium perborate-tetrahydrate, calcium metaborate-hexahydrate, potassium pentaborate, potassium tetraborate, and mixtures thereof. An alternative borate compound is sodium borosilicate obtained by heating waste borosilicate glass to a temperature sufficient to dehydrate the glass.

The structure of the granules can be controlled or selected based upon the application or use in a building construction article. The granules can have homogeneous distributions of pores and pigments, or can have regions within the granules that have different properties. For example, the granules can have core regions with one level of porosity or pigment, and shell or surface regions with a different level of pigment or porosity. Additionally, the granules can be regularly or irregularly shaped. The granules can also have a variety of shape profiles including, but not limited to, spherical, blocky, plate-like, or disk-like. The granules can also be engineered to have a desired shape and blended to provided preferred size and/or shape distributions for optimum packing, coverage, texture, or appearance on bituminous surfaces or for other functions. In various exemplary embodiments, exemplary granules may be shaped to exhibit a microstructure on an outer surface of the granule. A granule having a microstructured surface may improve adhesion of the granule when applied to a substrate to form a shingle, for example, thus reducing the need of an adhesion promoter. A granule exhibiting a microstructured surface may also exhibit desired optical properties, such as a desired level of reflectivity, for example.

In further exemplary embodiments, building materials derived from fine glass materials may include characteristics or additives to provide IR-absorbing, thermally conductive and/or electrically conductive building materials, such as IR-absorbing, thermally conductive and/or electrically conductive roofing granules. One or more IR-absorbing, thermally conductive and/or electrically conductive materials may be incorporated with a glass powder before the glass powder is sintered, fused, coalesced, and/or formed into a roofing granule, tile, or other suitable building material. In this way, IR-absorbing, thermally conductive and/or electrically conductive materials may be partially or completely incorporated throughout the glass substrate to provide a granule having IR-absorbing, thermally conductive and/or electrically conductive properties. In various embodiments, a granule includes greater than 15% volume of an IR-absorbing, thermally conductive and/or electrically conductive material. In an exemplary embodiment, a thermally conductive granule comprises about 82 weight % borosilicate glass, about 2 weight % red iron oxide, about 6 weight % ochre, and about 10 weight % carbon black. An exemplary electrically conductive granule comprises about 80 weight % borosilicate glass and about 20 weight % silver.

In other exemplary embodiments, building materials derived from fine glass materials may include characteristics or additives to provide algae resistant building materials, such as algae resistant roofing granules. In an exemplary embodiment, one or more additives can be incorporated with a glass powder before the glass powder is sintered, fused, coalesced, and/or formed into a roofing granule, tile, or other suitable building material. In this way, one or more additives providing algae resistant properties may be partially or completely incorporated throughout the glass substrate. Alternatively or in addition, one or more additives providing algae resistant properties may be coated onto the glass substrate. Such a coating may include an additive providing an algae resistant property and a binder, such as a silicate binder, or other suitable compositions used on traditional mineral roofing granules, for example, as known in the art. For example, U.S. Pub. No. 2010/0098777 describes algicidal compounds and coatings, and that may be incorporated with a glass powder before forming into a building material, or coated onto a building material, and incorporated herein by reference in its entirety.

Algicidal particles incorporated at least partially in or throughout, or coated onto, a glass substrate as described herein may include any suitable algicidal particles. In an exemplary embodiment, the algicidal particles include transition metal photocatalysts. Examples of suitable algicidal particles include cuprous oxide, cupric oxide, cupric bromide, cupric stearate, cupric sulfate, cupric sulfide, cuprous cyanide, cuprous thiocyanate, cuprous stannate, cupric tungstate, cuprous mercuric iodide, cuprous silicate, other copper containing materials, or mixtures thereof. In other exemplary embodiments, zinc containing materials, such as zinc oxides or zinc sulfides, silver containing materials, borates, or other suitable materials are incorporated at least partially in or throughout, or coated onto, the glass substrate. In an exemplary embodiment, an algicidal granule comprises about 89 weight % borosilicate glass, about 5 weight % titanium dioxide, about 5 weight % cuprous oxide, and about 1 weight % calcium carbonate.

As described above, building materials derived from fine glass materials may be fabricated to exhibit a desired porosity. Pore volume and pore size may be controlled in part by initial glass powder particle size distribution, and by the heat treatment time and temperature. Pores can also result from gas release during fabrication. The release of algicidal particles, such as copper-containing particles, incorporated at least partially in or throughout the glass substrate may be controlled by the porosity of the glass substrate. Alternatively or in addition, a porous coating may be applied over the glass substrate to control the release rate of the algicidal material.

In some exemplary embodiments, a glass substrate may be coated with a composition containing algicidal particles. For example, a glass substrate may be coated with a composition including between about 1% to about 60% weight percent solids of cuprous oxide and an appropriate ceramic binder. After applying a coating composition onto the glass substrate, the coated glass substrate is heated at elevated temperatures in a rotary kiln, oven, or other suitable apparatus, to produce a building material, such as a roofing granule, including a glass substrate and an algicidal coating. Additional porous coatings may be provided, before or after heating the coated glass substrate, to control the release of algicidal particles.

In various exemplary embodiments, building materials derived from fine glass materials may include characteristics or additives to provide photocatalytic building materials, such as photocatalytic roofing granules. Building materials incorporating photocatalysts may prevent discoloration of building materials caused by algae growth, airborne contaminants such as soot and grease, and other discolorants, by establishing oxidation and reduction sites upon activation or exposure to sunlight. The oxidation and reduction sites are believed to produce highly reactive species, such as hydroxyl radicals, capable of preventing or inhibiting growth of algae or other biota on the coated article, especially in the presence of water.

In an exemplary embodiment, one or more photocatalytic materials and/or compositions can be incorporated with a glass powder before the glass powder is sintered, fused, coalesced, and/or formed into a roofing granule, tile, or other suitable building material. In this way, one or more photocatalytic materials and/or compositions may be partially or completely incorporated throughout the glass substrate.

Alternatively or in addition, one or more photocatalytic compositions may be coated onto the glass substrate. For example, a glass substrate may be coated with a composition including between about 0.1 weight % and 90 weight % photocatalyst and an alkali metal silicate binder, which may include lithium silicate, sodium silicate, potassium silicate, and/or combinations thereof as described herein. In some exemplary embodiments, an alkoxysilane, such as tetraethoxysilane, and/or a boric acid, borate, or combination thereof, may be added to enhance the durability of the coating. After applying a coating composition onto the glass substrate, the coated glass substrate is heated at elevated temperatures in a rotary kiln, oven, or other suitable apparatus, to produce a colored building material, such as a colored roofing granule.

Photocatalytic particles incorporated in or throughout, or coated onto, a glass substrate as described herein may include any suitable photocatalytic particles. In an exemplary embodiment, the photocatalytic particles include transition metal photocatalysts. Examples of suitable transition metal photocatalysts include TiO₂, ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, and combinations thereof. Photocatalytic particles including crystalline anatase TiO₂, crystalline rutile TiO₂, crystalline ZnO and combinations thereof may be particularly suitable. To improve spectral efficiency, the photocatalytic particles may be doped with a nonmetallic element, such as C, N, S, F, or with a metal or metal oxide, such as Pt, Pd, Au, Ag, Os, Rh, RuO₂, Nb, Cu, Sn, Ni, Fe, or combinations thereof. In an exemplary embodiment, a photocatalytic granule comprises about 85 weight % borosilicate glass, about 4 weight % titanium dioxide pigment, about 1 weight percent calcium carbonate, and about 2 weight percent nano-sized photocatalytic titanium dioxide, such as P25 available from Evonik Industries.

In other exemplary embodiments, building materials derived from fine glass materials may include characteristics or additives to provide environmental filtering building materials, such as environmental filtering roofing granules. Environmental contaminants may be deposited on roofs from sources such as birds and wildlife, industrial air contaminants, rain water, and other sources. Exemplary environmental filtering granules exhibit suitable pore sizes and/or various additives that facilitate chemical bonding with the contaminant through chelation or adsorption, for example. In various exemplary embodiments, environmental filtering granules may capture mercury, or other pollutants, from the environment. In other exemplary embodiments, granules are able to collect or filter copper lost from other granules or available from other sources such that the copper may be recycled and reused to provide additional algicidal properties.

In various exemplary embodiments, building materials derived from fine glass materials may comprise a coating derived from fine glass particles. For example, a granule may comprise a base having a coating derived from fine glass particles and including any of the features, characteristics, and/or additives as described herein. In some exemplary embodiments, the base is a traditional mineral substrate as may be commonly used in roofing granules. A glass coating, such as a sintered glass layer, covers all or a portion of the base to provide a granule having desired features and characteristics.

Building materials derived from fine glass materials as described herein are believed to provide several advantages. For example, granules from fine glass materials that are sintered, fused, coalesced or otherwise formed at a relatively low temperature near a softening point of the fine glass materials allow pigments and/or other additives mixed with the fine glass particle to exist undamaged and/or unchanged on or within the glass substrate. That is, the pigments and/or other additives may be partially or completely incorporated throughout the glass substrate of the granule while not being functionally altered by the manufacturing process, resulting in a roofing granule having a high percentage of glass and features and characteristics as may be desired for a particular application.

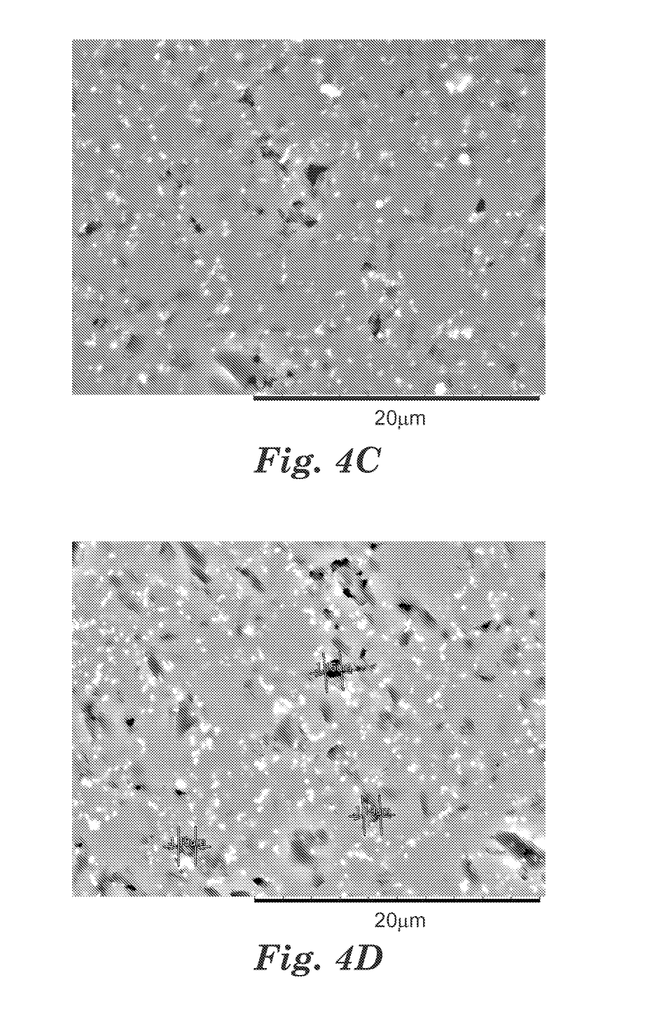

Building materials derived from fine glass particles may be incorporated into suitable building products, such as shingles, roll roofing, cap sheets, stone coated tile, as well as other non-roofing surfaces, such as walls, roads, walkways, and concrete. FIG. 3 shows an exemplary roofing product including a plurality of roofing granules 310 according to the present invention distributed on a surface and some or all granules include greater than 50% by volume of a glass. Roofing product 300 includes a binder layer 320 that binds granules 310 to substrate layer 330. In some exemplary embodiments, substrate layer 330 may be an asphalt-based substrate including an asphalt saturated material. In other exemplary embodiments, substrate layer 330 may be a film or intermediate layer that may be subsequently joined to an asphalt-based substrate or other substrate. As described herein, granules 310 exhibit a relatively high % volume of a glass and may exhibit various features or characteristics, or incorporate various additives, coatings, or other modifications to exhibit desired colors, infrared-reflective properties, infrared-absorbing properties, algicidal properties, photocatalytic properties, thermally conductive properties, electrically conductive properties, environmentally filtering properties, and/or other features and characteristics.

### EXAMPLES

The characteristics, operation, and advantages of the present invention will be further described with regard to the following detailed non-limiting examples. These examples are offered to further illustrate the various specific and exemplary embodiments and techniques. It should be understood, however that many variations and modifications may be made while remaining within the scope of the present invention.

Three methods of processing were used to generate granule samples for testing: (1) Glass is wet milled, slurry is dried, fired, and then crushed into −12+40 grade (Examples 1-3); (2) Glass is wet milled, slurry is shaped and dried in mold, released from mold, and fired (Examples 4a-4e); (3) Glass is wet milled, slurry is dried, crushed into −12+40 grade, and then fired. (Examples 5-9). Results for samples made using each of the three processing methods are shown in Tables 1-3.

For all examples, reflectivity was measured using a model SSR-ER v6 Solar Spectrum Reflectometer, available from Devices and Services Co. of Dallas, Tex., using a 1.5E air mass setting. For “Cup” measurements, granules were loaded into a sample holder with a depth of approximately 5 mm. The surface of the granules was leveled using a roller. For “Flat” measurements, granules were poured over 471 black vinyl tape, available from 3M Co. of St. Paul, Minn., and pressed to adhere. Pouring and pressing steps repeated 3 to 5 times to ensure good granule coverage on the tape.

For all examples, coverage was measured using I-SOLUTION image analysis software available from IMT-Digital. Area analysis was performed using a manual thresholding tool to determine percentage of the black surface covered by the granules.

Examples 1-3 were prepared by attritor milling glass, obtained by crushing unused clear glass vials of a borosilicate composition. The attritor milling was performed using a Union Process Model 01HD/HDDM Attritor, and adding glass to H₂O at 70% solids loading, and milling with 5 mm yttria-stabilized-zirconia (YSZ) media for three hours. The median primary particle size after milling was 1.3 microns. The slurry was divided into three equal portions, and to each portion was added different types and amounts of pigments (in percentages based on weight of glass solids), as shown in Table 1. After adding the pigments, the slurries were ball milled for approximately one hour with 5 mm YSZ media to homogeneously disperse the pigments. The three prepared slurries were then poured into Pyrex dishes lined with Teflon film, and dried in an oven at 100° C. overnight. The dried slurry “slabs” were then heat treated at 850° C. for four minutes in a box furnace. This heat treatment allowed for viscous sintering of the glass particles to occur and to trap both pores and pigments. The sintered glass slabs were then crushed using a mortar and pestle and sieved to obtain a −12+40 size fraction for analysis. Results are shown below in Table 1.

TABLE 1

| Example | 1 | 2 | 3 |
|---|---|---|---|
| HT Temp (° C.) | 850 | 850 | 850 |
| Time (min) | 6 | 6 | 6 |

Raw Materials

| | | | |
|---|---|---|---|
| Clean Milled Vial Glass | 91 | 93 | 84 |
| Laponite-RDS | 1 | 1 | 1 |
| RCL-9 TiO₂ | 4 | 6 | 5 |
| AC34 Al₂O₃ | 0 | 0 | 10 |
| Gold Seal ZnO | 4 | 0 | 0 |

Reflectivity

| | | | |
|---|---|---|---|
| Cup −12 + 40 | 0.869 | 0.881 | 0.877 |
| Cup −16 + 20 | — | 0.863 | 0.853 |
| Flat −12 + 40 | 0.655 | 0.702 | 0.685 |
| Flat −16 + 20 | 0.620 | 0.664 | 0.672 |

Coverage

| | | | |
|---|---|---|---|
| −12 + 40 | 0.933 | 0.940 | 0.929 |
| −16 + 20 | 0.887 | 0.893 | 0.895 |

Examples 4a-4e were prepared using a slurry-making process similar to that for Examples 1-3. Examples 4a-4e were compositionally identical to Example 2, which had the highest TSR value of the first 3 examples, 0.702, on a flat black tape. The median glass particle size in the slurry was 1.3 microns. The slurry batch with added pigments was shaped into 2 mm×2 mm×0.5 mm cavities, dried, and then released from the mold. The resulting “tiles” were then fired to various temperatures for either four or eight minutes as represented by Examples 4a-4e shown in Table 2 below and scanning electron microscope (SEM) images revealing the degree of trapped porosity in these samples are shown in FIGS. 4A-4E, respectively.

TABLE 2

| Example | 4a | 4b | 4c | 4d | 4e |
|---|---|---|---|---|---|
| HT Temp (° C.) | 700 | 700 | 750 | 750 | 800 |
| Time (min) | 4 | 8 | 4 | 8 | 4 |

Raw Materials

| | | | | | |
|---|---|---|---|---|---|
| Clean Milled Vial | 93 | 93 | 93 | 93 | 93 |
| Glass | | | | | |
| Laponite-RDS | 1 | 1 | 1 | 1 | 1 |
| RCL-9 TiO₂ | 6 | 6 | 6 | 6 | 6 |

Reflectivity

| | | | | | |
|---|---|---|---|---|---|
| Cup 2 × 2 × 0.5 mm | | 0.878 | | | |
| Flat 2 × 2 × 0.5 mm | 0.672 | 0.644 | 0.630 | 0.605 | 0.633 |

Coverage

| | | | | | |
|---|---|---|---|---|---|
| Flat 2 × 2 × 0.5 mm | 0.835 | 0.775 | 0.7732 | 0.7836 | 0.804 |

Examples 5-9 were prepared using a slurry-making process similar to that for Examples 1-3. Primary glass particle sizes in the slurries ranged from median values of 1.2 to 1.5 microns. The slurries with added pigments were pan-dried, similar to that for Examples 1-3. The dried slurry cakes were then crushed using a mortar and pestle, and the crushed particles were sieved to obtain a −12+40 size fraction for analysis. The resulting green granules were then fired to various temperatures for either four or seven minutes. Results are shown below in Table 3.

TABLE 3

| Example | 5 | 6 | 7 | 8 | 9 |
|---|---|---|---|---|---|
| HT Temp (° C.) | 775 | 750 | 775 | 775 | 875 |
| Time (min) | 7 | 4 | 7 | 7 | 7 |

Raw Materials

| | | | | | |
|---|---|---|---|---|---|
| Clean Milled Vial | 91.5 | 91.5 | 91 | 91 | 89 |
| Glass | | | | | |
| Laponite-RDS | 1.5 | 1.5 | 0 | 3 | 1 |
| RCL-9TiO₂ | 7 | 7 | 6 | 6 | 10 |
| CaSiO₃ | 0 | 0 | 3 | 0 | 0 |

Reflectivity

| | | | | | |
|---|---|---|---|---|---|
| Cup −12 + 40 | 0.892 | 0.900 | 0.867 | 0.890 | 0.892 |
| Flat −12 + 40 | 0.715 | 0.716 | 0.665 | 0.691 | 0.701 |

Coverage

| | | | | | |
|---|---|---|---|---|---|
| Flat −12 + 40 | 0.920 | 0.913 | 0.877 | 0.924 | 0.904 |

The present invention has now been described with reference to several embodiments thereof. The foregoing detailed description and examples have been given for clarity of understanding only. No unnecessary limitations are to be understood there from. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures. Any feature or characteristic described with respect to any of the above embodiments can be incorporated individually or in combination with any other feature or characteristic, and are presented in the above order and combinations for clarity only.

1. A building material, comprising a roofing granule including greater than 50% by volume of a glass.

2-3. (canceled)

4. The roofing granule of claim 1, wherein the glass is selected from the group consisting of silicate glass, soda lime silica glass, borosilicate glass, aluminosilicate glass, phosphate glass, borate glass, pre-fused glass, recycled glass, and manufactured glass.

5-6. (canceled)

7. The building material of claim 1, wherein the roofing granule has greater than 3% by volume of closed pores and less than 5% by volume of open pores.

8. (canceled)

9. The building material of claim 1, wherein the roofing granule further includes an additive distributed at least partially throughout the glass.

10. (canceled)

11. The building material of claim 9, wherein the additive includes a colored pigment.

12. The building material of claim 9, wherein the additive includes a titania.

13. The building material of claim 9, wherein the additive includes photocatalytic particles.

14. (canceled)

15. The building material of claim 9, wherein the additive includes algicidal particles.

16. (canceled)

17. The building material of claim 9, wherein the additive includes infrared-reflective particles.

18. The building material of claim 9, wherein the additive includes infrared-absorbing particles.

19. The building material of claim 9, wherein the additive includes thermally conductive particles.

20. The building material of claim 9, wherein the additive includes electrical conductive particles.

21-22. (canceled)

23. A building material, comprising a roofing granule having greater than 50% by volume of a glass-ceramic.

24. The building material of claim 23, wherein the roofing granule further includes an additive distributed at least partially throughout the glass-ceramic.

25. (canceled)

26. A roofing product, comprising a plurality of roofing granules comprising greater than 50% by volume of a glass distributed on a substrate, wherein each roofing granule includes an additive distributed at least partially throughout the roofing granule, the additive selected from the group consisting of colored pigments, infrared-reflective particles, infrared-absorbing particles, algicidal particles, photocatalytic particles, thermally conductive particles, and electrically conductive particles.

27. A method of making a roofing granule, the method comprising:
processing bulk glass into a fine glass powder;
disposing the fine glass powder in a forming device and forming a green body; and
heat treating the green body to cause at least partial densification of the glass powder.

28. The method of claim 27, wherein the processing step comprises processing the bulk glass into glass powder having particle sizes of about 0.3 μm to about 10 μm.

29-30. (canceled)

31. The method of claim 27, wherein the forming device forms a green body in the shape of a granule having a diameter between 300 μm and 5000 μm.

32. The method of claim 27, wherein the forming device forms granules having a microstructured surface.

33-35. (canceled)

36. The method of claim 27, wherein the heat treating step comprises heating the fine glass powder to a temperature near or above a softening temperature of the fine glass powder.

37. (canceled)
